(19) United States
(12) Patent Application Publication
(10) Pub. No.: US 2009/0285312 A1
(43) Pub. Date: Nov. 19, 2009

(54) Distribution of bits over radio channels taking account of radio channel quality

(76) Inventors: Axel Heim, Ulm (DE); Martin Weckerle, Ulm (DE)

Correspondence Address: STAAS & HALSEY LLP, SUITE 700, 1201 NEW YORK AVENUE, N.W., WASHINGTON, DC, 20005, US

(21) Appl. No.: 12/227,651

(22) PCT Filed: May 24, 2007
(86) PCT No.: PCT/EP2007/055041

§ 371 Date: Jun. 8, 2009

(30) Foreign Application Priority Data
May 24, 2006 (EP) 06010767.9

(51) Int. Cl. H04L 27/00

(52) U.S. Cl. 375/259

(57) ABSTRACT

A transmitter, provided with a sequence of bits for transmission to a receiver, carries out coding of the bit sequence and distribution of the bits of the coded bit sequence over a number of radio channels according to a distribution pattern. Based on the distribution pattern, important features of the bits of the coded bit sequence and information regarding a quality of at least one of the radio channels are taken into account. These important features correspond to a significance of each bit on decoding by the receiver. The transmitter transmits the bits of the coded bit sequence using the number of radio channels according to the executed distribution.

### CROSS REFERENCE TO RELATED APPLICATIONS

This application is based on and hereby claims priority to European Application No. 06010767 filed on May 24, 2006, the contents of which are hereby incorporated by reference.

### BACKGROUND

Described below is a method for communication by radio, in which a bit string to be sent to a receiver is available to a transmitter, the transmitter encodes the bit string and uses a distribution pattern to distribute the bits in the encoded bit string over a plurality of radio channels.

In radio communication systems, messages, for example with voice information, picture information, video information, SMS (short message service), MMS (multimedia messaging service) or other data, are transmitted between transmitter and receiver via a radio interface using electromagnetic waves. In this case, depending on the specific embodiment of the radio communication system, the radio stations may be various kinds of subscriber stations or network-based radio stations, such as repeaters, radio access points or base stations. In a mobile radio communication system, at least some of the subscriber stations are mobile radio stations. The electromagnetic waves are emitted at carrier frequencies which are in the frequency band provided for the respective system.

Such mobile radio communication systems are often in the form of cellular systems, e.g. based on the GSM (global system for mobile communication) or UMTS (universal mobile telecommunications system) standard, with a network infrastructure having base stations, devices for monitoring and control of the base stations, and further network-based devices, for example. Apart from these widely organized (supralocal) cellular, hierarchic radio networks, there are wireless local area networks (WLANs) with a radio coverage area which is normally physically limited to a much greater extent. Examples of different standards for WLANs are HiperLAN, DECT, IEEE 802.11, Bluetooth and WATM.

In radio communication systems, the access by subscriber stations to the common transmission medium is regulated by multiple access methods/multiplex methods (MA). This multiple access allows the transmission medium to be split between the subscriber stations in the time domain (Time Division Multiple Access, TDMA), in the frequency domain (Frequency Division Multiple Access, FDMA), in the code domain (Code Division Multiple Access, CDMA) or in the space domain (Space Division Multiple Access). Combinations of multiple access methods are also possible, such as the combination of a frequency division multiple access method with a code division multiple access method.

To achieve the most efficient transmission of data possible, the entire available frequency band can be broken down into a plurality of subbands (multicarrier methods). The idea on which the multicarrier systems are based is to transfer the initial problem of transmitting a broadband signal to the transmission of a plurality of narrowband signals. An example of a multicarrier transmission method is OFDM (Orthogonal Frequency Division Multiplexing), in which pulse forms which are approximately rectangular over time are used for the subbands. The frequency interval of the subbands is chosen such that in the frequency domain, at that frequency at which the signal in one subband is evaluated, the signals in the other subbands exhibit a zero crossing.

When bits are transmitted via a radio channel, channel encoding methods are usually used in order to ensure reliable transmission which is as accurate as possible.

Channel encoding is an encoding method in which the properties of a transmission channel are taken into account in order to increase the redundancy of data to be transmitted specifically for the purpose of error recognition and/or error correction. Examples of channel encoding methods are block encoding and convolutional encoding. In contrast to this, source encoding reduces redundancy.

At the transmitter end, the encoder converts bits to be encoded into encoded bits and maps the encoded bits into symbols which are then transmitted to the receiver via the channel. During the transmission, the symbols are normally corrupted by interfering influences. The task of the decoder at the receiver end is to recognize any transmission errors which have occurred and to ascertain the original bits from the received, corrupted signal.

### SUMMARY

An aspect is presenting a transmitter-end method in which a transmitter encodes a bit string and sends it on a plurality of radio channels, and also a corresponding receiver-end method. In addition, the aim is to present a transmitter, a receiver and computer program products for carrying out the methods.

In the case of the first method for communication by radio, a bit string to be sent to a receiver is available to a transmitter. The transmitter encodes the bit string. Using a distribution pattern, the transmitter distributes the bits in the encoded bit string over a plurality of radio channels. The distribution pattern is taken as a basis for taking account of significances of the bits in the encoded bit string, with the significances corresponding to a weight of the respective bit during decoding by the receiver. In addition, the distribution pattern is taken as a basis for taking account of information relating to a quality of at least one of the radio channels. The transmitter sends the bits in the encoded bit string using the plurality of radio channels on the basis of the distribution performed.

At the transmitter end, encoding converts a first bit string into a second bit string, with an encoding specification being used. If the receiver knows the encoding specification, it can use a corresponding decoding specification to recover the original bit string from the encoded bit string. The encoding performed by the transmitter may be channel encoding, such as convolutional encoding or turbo encoding, which add redundancy to the original bit string.

Before the bits are sent, they are distributed over various radio channels. By way of example, the radio channels may be various subbands of a frequency band, various codes, or various directions in space. As an example, orthogonal radio channels may be available. The radio channels used for sending the bits to the receiver may have been assigned to the receiver for communication with the transmitter or may have been assigned to the transmitter for communication with the receiver, previously. For the distribution of the bits over the radio channels, it is possible for each of the plurality of the radio channels to have precisely one bit in the encoded bit string allocated to it; it is also possible for a plurality of bits to be allocated to individual radio channels.

For the distribution of the bits, significances of the bits are taken into account. This means that in this case, for at least one bit in the encoded bit string, the significance of the bit is taken into account. The respective significance may be taken into account for all the bits in the encoded bit string. The significance is a variable which is stipulated using the weight of a bit or of information about this bit in the course of the receiver-end decoding. Accordingly, a significant bit has a great weight for the successful decoding by the receiver, while an insignificant bit has only little weight for the decoding result.

In addition to the significances, information relating to the quality of at least one of the radio channels is taken into account for the distribution of the bits over the radio channels. It is possible for this information to relate just to one radio channel, to a plurality of radio channels or else to every radio channel in the considered plurality of radio channels. In this case, the quality of a radio channel can be assessed using various criteria, e.g. using the radio channel attenuation.

When the distribution pattern has been applied to the bits and before the bits are sent on the respective radio channels corresponding to the distribution, the transmitter end can perform further operations, such as modulation and digital/analog conversion. If a higher-level modulation alphabet is used for this, it should be ensured that only bits with the same significance are allocated to each symbol.

In the case of the second method for communication by radio, a receiver receives information on a plurality of radio channels. The receiver ascertains values from the information. The receiver uses a distribution pattern to create a value string from the values. The distribution pattern is taken as a basis for taking account of significances of the values in the value string, with the significances corresponding to a weight of the respective value during decoding by the receiver. In addition, the distribution pattern is taken as a basis for taking account of information relating to a quality of at least one of the radio channels. The receiver decodes the created value string.

The receiver ascertains values from received information. If the receiver receives an analog signal and performs analog/digital conversion with hard decision, the values are bits. If the receiver receives an analog signal and performs analog/digital conversion with soft decision, the values are probabilities (likelihood values). The statements above relating to the transmitter-end method can accordingly also be applied to the receiver-end method with the proviso that bits are not necessarily present at the receiver end.

The transmitter and the receiver may use the same distribution pattern. Hence, the receiver-end approach is equivalent to the inverse of the transmitter-end approach. This means that the transmitter-end order of the encoded bits can be recovered in the corresponding order of the receiver-end value string. To ensure that a consistent distribution pattern is used, the transmitter is able to notify the receiver, or the receiver is able to notify the transmitter, of which distribution pattern is to be applied. Alternatively, the transmitter and receiver may get to the same distribution pattern independently of one another using the same underlying strategy without explicitly communicating the distribution pattern to the respective other communication partner.

In one development, previously a decision is made about the distribution pattern to be used, specifically using information relating to radio propagation conditions between the transmitter and the receiver. This decision can be made by the transmitter or by the receiver, wherein the communication partner making the decision may notify the other of which distribution pattern is to be applied. The dependency of the distribution pattern on the radio propagation conditions allows a dynamic approach with customization to changing radio transmission conditions, which allows the quality of the communication between transmitter and receiver to be increased.

In line with one refinement, previously the receiver sends the transmitter the information relating to the quality of at least one of the radio channels. Thus, the receiver is able to determine the quality of one, a plurality or all of the radio channels and to inform the transmitter of this subsequently. This information transmitted to the transmitter may correspond to the complete information ascertained by the receiver or else just to some of it, or else may be derived from measurement results of the receiver. The information relating to the quality of at least one of the radio channels may relate to precisely one of the radio channels. This allows radio resources to be saved in the direction of transmission from the receiver to the transmitter.

It is advantageous if the distribution pattern specifies correlations between a respective position within a string, on the one hand, and a radio channel, on the other. This could be presented as a table, for example, with a first column containing the positions and a second column containing the radio channel which corresponds to the position in the same row. In reference to the transmitter, the string is the encoded bit string, and in reference to the receiver, it is the value string to be created.

In line with one development, the distribution pattern includes an allocation of insignificant bits and/or values to radio channels with poor quality. This involves at least one bit and/or value which has a low value for the significance being allocated to a channel which has a low value for the quality. Also, symmetrical distribution of insignificant bits and/or values around a radio channel with poor quality is advantageous.

This allows similarities between adjacent radio channels to be taken into account.

The significances may be taken into account using an allocation specification which allocates a significance to each position within a string. This allocation specification can be stipulated regardless of the information which is actually sent or received, and hence may have an a priori definition. What is relevant to the allocation of the significances is therefore not the specific value but rather the position in a string. When the allocation specification is used by the transmitter, the string is the bit string containing the encoded bits, and when the allocation specification is used by the receiver, the string is the value string to be created from the values by the receiver.

In one refinement, a failed transmission from the transmitter to the receiver is followed by a different distribution pattern being used for repeat processing of the same information. This approach, which is suitable for ARQ methods, can be applied both by the transmitter and by the receiver.

The transmitter for communication by radio has available a bit string to be sent to a receiver. It encodes the bit string, and distributes the bits in the encoded bit string over a plurality of radio channels using a distribution pattern. The distribution pattern is taken as a basis for taking account of significances of the bits in the encoded bit string, with the significances corresponding to a weight of the respective bit during decoding by the receiver. In addition, the distribution pattern is taken as a basis for taking account of information relating to a quality of at least one of the radio channels. Furthermore, the transmitter sends the bits in the encoded bit string using the plurality of radio channels on the basis of the distribution performed.

The receiver for communication by radio receives information on a plurality of radio channels, and also ascertains values from the information, and creates a value string from the values using a distribution pattern. The distribution pattern is taken as a basis for taking account of significances of the values in the value string, with the significances corresponding to a weight of the respective value during decoding by the receiver. In addition, the distribution pattern is taken as a basis for taking account of information relating to a quality of at least one of the radio channels. Finally, the receiver decodes the created value string.

The computer program product for a transmitter for communication by radio, to which a bit string to be sent to a receiver is available, encodes the bit string, and also distributes the bits in the encoded bit string over a plurality of radio channels using a distribution pattern. The distribution pattern is taken as a basis for taking account of significances of the bits in the encoded bit string, with the significances corresponding to a weight of the respective bit during decoding by the receiver. In addition, the distribution pattern is taken as a basis for taking account of information relating to a quality of at least one of the radio channels.

The computer program product for a receiver for communication by radio, to which values ascertained from information received on a plurality of radio channels are available, creates a value string from the values using a distribution pattern. The distribution pattern is taken as a basis for taking account of significances of the values in the value string, with the significances corresponding to a weight of the respective value during decoding by the receiver. In addition, the distribution pattern is taken as a basis for taking account of information relating to a quality of at least one of the radio channels. Finally, the computer program product for a receiver decodes the created value string.

In connection with the following, a computer program product is understood to mean not only the actual computer program (with its technical effect which goes beyond normal physical interplay between program and computation unit), particularly a recording medium for the computer program, a collection of files, a configured computation unit, but also, by way of example, a memory apparatus or a server storing files appertaining to the computer program.

The transmitter, the receiver and the computer program products are particularly suitable for carrying out the methods, this also being applicable to the refinements and developments.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a block diagram illustrating a transmitter and a receiver in a radio communication system,

FIG. 2 is a graph of a frequency band.

### DETAILED DESCRIPTION OF EXEMPLARY EMBODIMENTS

Reference will now be made in detail to exemplary embodiments, examples of which are illustrated in the accompanying drawings, wherein like reference numerals refer to like elements throughout.

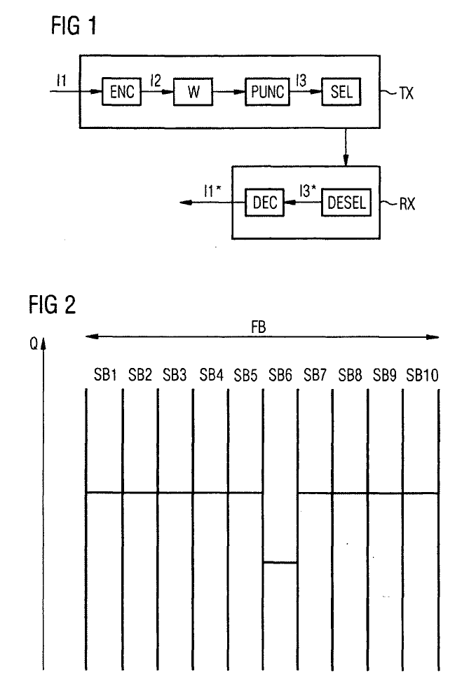

FIG. 1 shows a radio station TX and a radio station RX which communicate with one another by radio. The illustration of the radio stations TX and RX is highly simplified, and only components which are particularly relevant are shown. The radio station TX may be a network-based radio station, for example, and the radio station RX may be a subscriber station in a mobile radio communication system. In this case, communication in the downlink is considered. However, the method can also be applied to communication in the uplink.

The communication between the radio station TX and the radio station RX takes place using a frequency band FB which is shown in FIG. 2. The frequency band FB is broken down into ten equidistant subbands SB1 to SB10. Accordingly, multicarrier technology, such as OFDM, is used for the radio transmission. The split of the frequency band FB into the 10 subbands in FIG. 2 is just one example, and real systems often have a much greater number of subbands. The ten subbands SB1 to SB10 or the frequency band FB may be a section from a broader frequency band, this section being used for the communication between the radio stations TX and RX.

For the subbands SB1 to SB10, the radio station RX determines a respective variable which indicates the transmission quality on the individual subbands SB1 to SB10 for a signal transmission from the radio station TX to the radio station RX. By way of example, the quality variable used may be the signal attenuation. To this end, the radio station TX sends signals at a transmission strength known to the radio station RX on the subbands SB1 to SB10, whereupon the radio station RX measures the reception strength and uses the ratio of reception strength to transmission strength to ascertain the attenuation. Even without knowledge of the transmission strength, the radio station RX is able to ascertain a relative measure of quality by comparing the received signal level of the signals received on the different subbands, which allows the relatively poorest subband(s) to be identified.

When the quality of the subbands SB1 to SB10 has been determined, the radio station RX sends the radio station TX a quality variable Q. The purpose of this approach is to allow the best possible transmission quality to be attained for future message transmission from the radio station TX to the radio station RX, or to allow the highest possible data rate to be attained for a particular transmission quality. In general, this is more successful the more detailed the quality variable Q transmitted by the radio station RX. To this end, it would be advantageous to specify the quality of each subband SB1 to SB10. However, this requires a large outlay of radio resources in the transmission direction from the radio station RX to the radio station TX. This is true particularly for the case in which a multiplicity of subbands are present.

So as to have to lay out few radio resources for the transmission of the quality variable Q, the radio station RX sends the radio station TX only information relating to a portion of the measurements performed by it, namely the information that the poorest transmission quality has been found for the subband SB6. The radio station TX therefore provides itself with the picture shown in FIG. 2 in reference to the quality variable Q transmitted to it: the subbands SB1, SB2, SB3, SB4, SB5, SB7, SB8, SB9 and SB10 are good, while the subband SB6 is poor. This corresponds to a binary representation or a binary quality variable Q.

When the quality variable Q is transmitted as explained, only a single variable is signaled, namely a piece of identification information for a subband. This is merely one example. The quality variable Q transmitted to the radio station TX, as shown in FIG. 2, provides a good description of the real quality situation when a single narrow deep fading hole is present, while the transmission quality for the subbands outside this dip is approximately constant. If, by contrast, there were a dip in the transmission quality several subbands wide then it would be more advantageous for the quality variable Q signaled to be a plurality of adjacent subbands over which this wide dip in the transmission quality extends. If there were a plurality of narrow deep fading holes, on the other hand, then it would be suitable for a plurality of subbands which are respectively at the deepest point of a fading hole to be signaled as quality variable Q.

In this way, it is possible to define a plurality of types of quality variables Q which can be signaled. In order to customize the quality variable Q which the radio station RX provides for the radio station TX to the real situation, it is advantageous if the radio station RX—on the basis of the qualities it has determined for the subbands SB1 to SB10—selects the type of the quality variable Q which is to be signaled. In order to indicate to the radio station TX the type on which the radio station RX has decided, it is possible to use a dedicated piece of signaling information for the explicit indication of the type. Alternatively, it is also possible for the radio station TX to be able to use the received quality variable Q to ascertain what type is involved.

The text below explains the way in which the radio station TX uses its knowledge about the quality variable Q. In FIG. 1, the radio station TX has a bit string I1 available which needs to be sent to the radio station RX. This may be a piece of useful and/or signaling information. As is usual with radio transmissions, the bit string I1 is channel encoded by an encoder ENC. By way of example, the encoder ENC may be a simple convolutional encoder or else a turbo encoder, which involves the use of a plurality of convolutional encoders in parallel.

The channel encoding adds redundancy to the bit string I1, so that the bit string I2 which is output by the encoder ENC includes a larger number of bits than the original bit string 11. The bits in the bit string I2 subsequently have significances W allocated to them. In this case, the significance W of a bit indicates how valuable the presence of this bit is in the bit on which the radio station RX bases the decoding. If not received correctly by the radio station RX, the most significant bit would therefore cause the greatest impairment of the decoding result, the second most significant bit would cause the second greatest impairment, etc.

In this case, the significances W are allocated independently of the value of a bit, but rather on the basis of the position of a bit within the bit string I2. A specification is used which allocates a particular value of the significance W to each position within a bit string. Such allocation of significances can be effected for turbo codes on the basis of the method presented in Rowitch, Milstein: “On the Performance of Hybrid FEC/ARQ Systems Using Rate Compatible Punctured Turbo (RCPT) Codes”, IEEE Trans. Comm. 2000, for example, In this case, assuming periodic puncturing of systematic and redundancy bits of turbo codes and the code ratio compatibility condition, i.e. every more severely punctured code is a subcode for a less severely punctured code from the same mother code, puncturing matrices for codes are specified which minimize the decoding error probability for a given encoding rate or optimize a measure correlated to the error probability. The matrices are determined such that, starting from the unpunctured encoded bits, every possible encoding rate resulting from the puncturing period has successive puncturing of the respective bit at that position, together with the relevant bits at the periodic interval, for which the losses in terms of decoding performance are lowest. In this case, the significance is respectively determined relative to the code bits actually sent, i.e. the code bit string is punctured, and thus the punctured code bits are no longer involved in determining the significance. The least significant code bits are now the code bits which would be removed during further puncturing.

Although the use of the stated puncturing matrices is advantageous for determining the significances W, it is also possible to use other methods for this. In particular, it is possible to take account of the fact that tail bits should have a high significance W in principle. It is subsequently assumed that a specification exists which allocates a significance W to each position in a bit string taking into account the receiver-end decoding method, so that a significance W can be allocated to each bit in the bit string I2.

Next, the bit string I2 is punctured in the component PUNC of the radio station TX. This means that the number of bits to be sent to the radio station RX can be customized to the scope of the radio resources available for this. The puncturing involves the use of the significances W, so that only the least significant bits are removed from the bit string I2. The bit string I3 leaving the component PUNC therefore contains fewer bits than the bit string I2. The puncturing is optional and can be omitted if appropriate. In the example under consideration, the puncturing is effected such that the bit string I3 includes 10 bits, in line with the number of subbands SB1 to SB10.

The bits in the bit string I3 are those bits which need to be sent to the radio station RX on the subbands SB1 to SB10. The component SEL distributes the bits in the bit string I3 over the subbands SB1 to SB10 for sending on the basis of their significance W. This involves the use of the quality variable Q transmitted to the radio station TX by the radio station RX. For distributing the bits in the bit string I3 over the subbands SB1 to SB10, the radio station TX uses an arrangement specification which is known to the radio station RX. The text below explains a simple arrangement specification, with a first arrangement pattern for the poorest 5 bits and a second arrangement pattern for the best 5 bits, by way of example.

On the basis of the first arrangement pattern for the 5 least significant bits:
The bit with the least significance W is allocated to the subband SB6 with the poorest quality.
The bit with the second least significance W is allocated to the subband SB5, which is situated to the left of the subband SB6 with the poorest quality.
The bit with the third least significance W is allocated to the subband SB7, which is situated to the right of the subband SB6 with the poorest quality.
The bit with the fourth least significance W is allocated to the subband SB4, which is situated two subbands to the left of the subband SB6 with the poorest quality.
The bit with fifth least significance W is allocated to the subband SB8, which is situated two subbands to the right of the subband SB6 with the poorest quality.

In addition, on the basis of the second arrangement pattern for the 5 most significant bits:
The bit with the sixth least and hence the fifth most significance W is allocated to the first subband SB1.
The bit with the seventh least and hence fourth most significance W is allocated to the second subband SB2.
The bit with the eighth least and hence third most significance W is allocated to the third subband SB3.
The bit with the ninth least and hence second most significance W is allocated to the ninth subband SB9.
The bit with the tenth least and hence most significance W is allocated to the tenth subband SB10.

The second arrangement pattern fills the subbands which have not been engaged by the first arrangement pattern from left to right with increasing significance W of the bits. Another example of a second arrangement pattern is the use of a random interleaving. If no information is available to the radio station TX in respect of the quality differences in the subbands which are not engaged by the first arrangement pattern, the configuration of the second arrangement pattern is arbitrary per se.

The first arrangement pattern corresponds to a symmetrical arrangement around the quality minimum. If this minimum is too close to an edge of the frequency band FB, the bits which would need to be arranged next to the minimum on the side of this edge can be arranged on the side of the other edge, for example.

The reason for the explained symmetrical arrangement around the minimum on the basis of the first arrangement pattern is that often subbands next to a poor subband likewise do not allow good transmission conditions. It is therefore advantageous to arrange the least significant bits in the surroundings of the poorest subband. Whether such similarity between adjacent subbands can be expected is described by the coherency bandwidth. With a very large coherency bandwidth, the case of “flat fading” is present, i.e. the transmission conditions are almost the same for all subbands. In this case, it is not necessary to allocate bits of little significance with the surroundings of the poorest subband. It is therefore possible to arrange all bits on the basis of the second arrangement pattern. With an average coherency bandwidth, there is similarity between a particular number of adjacent subbands; in this case, it is possible to proceed as explained in the example above. With a very small coherency bandwidth, on the other hand, the subbands behave independently of one another in practice, and the “deep fading” situation is present. In this case, it is sufficient to allocate only the least significant bit to the poorest subband and to proceed on the basis of the second arrangement pattern for the remaining bits.

To process the bits received by the radio station RX on the subbands SB1 to SB10, the radio station RX knows the arrangement specification used by the radio station TX. This can be done in various ways. It is thus possible for only a single arrangement specification to exist, so that a selection cannot be made in this respect and coordination between the radio stations TX and RX about the arrangement specification to be used is not necessary. If a plurality of arrangement specifications are available, either the radio station TX or the radio station RX can choose between them and notify the communication partner of the decision made.

It is advantageous if the radio station RX makes the decision about the arrangement specification to be used, because the fact that the radio station RX has determined the quality for the subbands SB1 to SB10 means that it has extensive knowledge about the transmission conditions, in contrast to the radio station TX. By way of example, the radio station RX can determine the coherency bandwidth and, on the strength of the considerations explained above, decide about the arrangement specification to be used on the basis of the current coherency bandwidth.

If the radio station TX decides about the arrangement specification to be used, on the other hand, then it is advantageous if the radio station RX provides it with information for this purpose.

By way of example, the radio station RX can notify the radio station TX of the coherency bandwidth which it has ascertained.

Different arrangement specifications may have different kinds of configuration of the transmitted quality variable Q linked to them. By way of example, it is thus possible for there to be a first arrangement specification, for which, as explained above, the radio station TX is notified only of the poorest subband, and a second arrangement specification, for which the radio station TX is notified of a plurality of subbands, corresponding to a plurality of fading dips, and also a third arrangement specification, for which the radio station TX is notified of a plurality of subbands, corresponding to a plurality of subbands within the same fading dip.

In reference to the transmission of the quality variable Q for the subbands, it should be borne in mind that it is advantageous to the saving of radio resources for little configuration to be provided for the resources. In reference to the signaling of the arrangement specification which is to be used, it should be borne in mind that the scope of the radio resources required for this purpose increases with the number of arrangement specifications between which it is possible to select. On the other hand, the presence of a plurality of selectable arrangement specifications allows the bits which are to be transmitted from the radio station TX to the radio station RX to be distributed over the subbands SB1 to SB10 in a manner which matches the current radio transmission conditions in the best way possible.

The arrangement specification to be used can be signaled explicitly by using a piece of signaling information sent specifically for these purposes. However, the arrangement specification to be used can also be derived from another piece of information, for example from the transmitted quality variable Q. With a plurality of usable arrangement specifications, the radio station TX and the radio station RX have an allocation table available between a respective arrangement specification and an explicit or implicit piece of signaling information.

The arrangement specification is a correlation between the position of a bit within a bit string, on the one hand, and the subband used for transmitting the bit, on the other. From the point of view of the radio station TX, the bit string is the bit string I3 produced by the encoding and puncturing. The radio station TX allocates the bits in the bit string I3 to the respective subbands SB1 to SB10 in the component SEL, and this allocation is taken as a basis for transmitting the bits in the bit string I3 from the radio station TX to the radio station RX.

The radio station RX receives an analog signal on the subbands SB1 to SB10. The radio station RX uses this analog signal in a manner which is known per se to ascertain bits or likelihood values, i.e. probabilities of a received value having been a 1 or a 0 at the transmitter end. Values are thus available, each value corresponding to one of the subbands SB1 to SB10 on which it was received. The component DESEL sorts these values into a particular order, so that a value string I3* is obtained. The aim of this sorting is to perform the reversal process for the allocation performed by the radio station TX in the component SEL. This is done using the same arrangement specification as the radio station TX uses for distributing the bits in the bit string I3 over the subbands SB1 to SB10. From the point of view of the radio station RX, the value string, whose individual positions are correlated by the arrangement specification with subbands SB1 to SB10, is the value string I3*. In the value string I3* created, a value in a particular position within the value string I3* thus appertains to the bit at the corresponding position within the bit string I3.

Next, the radio station RX decodes the value string I3*, i.e. it performs the reversal operations of the transmitter-end puncturing and decoding in a manner which is known per se. As the result, the decoder DEC outputs the bit string I1*.

The approach explained has the advantage that by taking account of the significances and the channel qualities it is possible to achieve a reduction in the bit error rate in comparison with distribution of the bits over subbands without taking account of these two variables. This also applies to cases in which—as explained with reference to FIG. 2—the radio station TX is provided with only little information relating to the quality variable Q of the channels.

The procedure explained can also be used as part of an ARQ (Automatic Repeat Request) method. For this, it is possible to provide, by way of example, for the radio station TX to use a particular arrangement specification, in principle, for repeat sending or always the same arrangement specification as for the first sending, so that the arrangement specification used for the repeat sending does not need to be signaled. In addition, to improve the repeat transmission in comparison with the original, provision may be made for a different arrangement specification than in the case of the original transmission to be used, in principle.

As explained, efficient transmission of information by radio is achieved by distributing bits over various channels on the basis of the significance of the bits. In this case, the advantageous situation has been considered that the various channels are various subbands of a frequency band. However, the method can also be applied to other radio channels, and it is thus possible for the bits to be distributed over various codes or various directions in space on the basis of their significance, in similar fashion to the approach explained.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-18. (canceled)

19. A method for communication by radio, comprising:
obtaining, at a transmitter, a bit string to be sent to a receiver;
encoding the bit string at the transmitter to produce an encoded bit string;
distributing bits in the encoded bit string over a plurality of radio channels by the transmitter using a distribution pattern taken as a basis for taking account of significances of the bits in the encoded bit string and information relating to a quality of at least one of the radio channels, the significances corresponding to weights of respective bits during decoding by the receiver, and
sending the bits in the encoded bit string from the transmitter using the plurality of radio channels based on said distributing.

20. The method as claimed in claims 19, wherein the transmitter and the receiver use substantially identical distribution patterns.

21. The method as claimed in claim 20, further comprising notifying the receiver of the distribution pattern, by the transmitter prior to said sending.

22. The method as claimed in claim 20, further comprising notifying the transmitter, by the receiver, of the distribution pattern to be used for said distributing.

23. The method as claimed in claim 22, further comprising making a decision about the distribution pattern, prior to said distributing, using information relating to radio propagation conditions between the transmitter and the receiver.

24. The method as claimed in claim 23, further comprising sending from the receiver to the transmitter information relating to quality of at least one of the radio channels.

25. The method as claimed in claim 24, wherein the information relating to the quality of at least one of the radio channels relates to precisely one of the radio channels.

26. The method as claimed in claim 25, wherein the distribution pattern specifies correlations between a respective position within a string and a radio channel.

27. The method as claimed in claim 26, wherein the distribution pattern includes an allocation of insignificant bits and/or values to radio channels with poor quality.

28. The method as claimed in claim 27, wherein the distribution pattern includes a symmetrical distribution of insignificant bits and/or values around a radio channel with poor quality.

29. The method as claimed in claim 28, wherein the significances are taken into account using an allocation specification which allocates a significance to each position within a string.

30. The method as claimed in claim 29, wherein a failed transmission of content from the transmitter to the receiver is followed by using a different distribution pattern for repeat processing of the content in the failed transmission.

31. The method as claimed in claim 30, wherein the radio channels are subbands of a frequency band.

32. A method for communication by radio, comprising:
receiving information at a receiver on a plurality of radio channels;
ascertaining values from the information at the receiver;
using a distribution pattern at the receiver to create a value string from the values, the distribution pattern taken as a basis for taking account of significances of the values in the value string and information relating to a quality of at least one of the radio channels, the significances corresponding to a weight of respective values during decoding by the receiver; and
decoding the value string at the receiver.

33. The method as claimed in claims 32, wherein the transmitter and the receiver use substantially identical distribution patterns.

34. The method as claimed in claim 33, further comprising notifying the receiver of the distribution pattern, by the transmitter prior to said sending.

35. The method as claimed in claim 33, further comprising notifying the transmitter, by the receiver, of the distribution pattern to be used for said distributing.

36. The method as claimed in claim 35, further comprising making a decision about the distribution pattern, prior to said distributing, using information relating to radio propagation conditions between the transmitter and the receiver.

37. The method as claimed in claim 36, further comprising sending from the receiver to the transmitter information relating to quality of at least one of the radio channels.

38. The method as claimed in claim 37, wherein the information relating to the quality of at least one of the radio channels relates to precisely one of the radio channels.

39. The method as claimed in claim 38, wherein the distribution pattern specifies correlations between a respective position within a string and a radio channel.

40. The method as claimed in claim 39, wherein the distribution pattern includes an allocation of insignificant bits and/or values to radio channels with poor quality.

41. The method as claimed in claim 40, wherein the distribution pattern includes a symmetrical distribution of insignificant bits and/or values around a radio channel with poor quality.

42. The method as claimed in claim 41, wherein the significances are taken into account using an allocation specification which allocates a significance to each position within a string.

43. The method as claimed in claim 42, wherein a failed transmission of content from the transmitter to the receiver is followed by using a different distribution pattern for repeat processing of the content in the failed transmission.

44. The method as claimed in claim 43, wherein the radio channels are subbands of a frequency band.

45. A transmitter for communication by radio, at which a bit string to be sent to a receiver is available, comprising:
means for encoding the bit string to produce an encoded bit string;
means for distributing bits in the encoded bit string over a plurality of radio channels using a distribution pattern, the distribution pattern taken as a basis for taking account of significances of the bits in the encoded bit string and information relating to a quality of at least one of the radio channels, the significances corresponding to a weight of respective bits during decoding by the receiver; and
means for sending the bits in the encoded bit string using the plurality of radio channels based on the distribution pattern.

46. A receiver for communication by radio, comprising:
means for receiving information on a plurality of radio channels;
means for ascertaining values from the information;
means for creating a value string from the values using a distribution pattern, the distribution pattern taken as a basis for taking account of significances of the values in the value string and information relating to a quality of at least one of the radio channels, the significances corresponding to a weight of respective values during decoding by the receiver; and
means for decoding the value string.

47. A computer-readable medium encoded with a computer program that when executed by a processor causes a transmitter to perform a method of communicating signals by radio, the signals including a bit string available to the transmitter, said method comprising
encoding the bit string at the transmitter to produce an encoded bit string; and
distributing bits in the encoded bit string over a plurality of radio channels by the transmitter using a distribution pattern taken as a basis for taking account of significances of the bits in the encoded bit string and information relating to a quality of at least one of the radio channels, the significances corresponding to weights of respective bits during decoding by the receiver.

48. A computer-readable medium encoded with a computer program that when executed by a processor causes a receiver to perform a method of communicating by radio, the receiver having available values ascertained from information received on a plurality of radio channels, said method comprising:
creating a value string from the values using a distribution pattern, the distribution pattern taken as a basis for taking account of significances of the values in the value string and information relating to a quality of at least one of the radio channels, the significances corresponding to a weight of respective values during decoding by the receiver; and
decoding the value string.
